(19) United States
(12) Patent Application Publication
(10) Pub. No.: US 2026/0075380 A1
(43) Pub. Date: Mar. 12, 2026

(54) Direction and Semantics Driven Ambisonic Target Sound Extraction

(71) Applicant: GDM Holding LLC, Mountain View, CA (US)

(72) Inventors: Sinan Hersek, Mountain View, CA (US); Tuochao Chen, Mountain View, CA (US); Dongeek Shin, San Jose, CA (US)

(73) Assignee: GDM Holding LLC, Mountain View, CA (US)

(21) Appl. No.: 19/325,773

(22) Filed: Sep. 11, 2025

Related U.S. Application Data
(60) Provisional application No. 63/694,158, filed on Sep. 12, 2024.

(51) Int. Cl. H04S 7/00; G06F 3/16; G06F 16/683; H04R 1/32

(52) U.S. Cl. CPC H04S 7/303; G06F 3/165; G06F 16/685; H04R 1/323

(57) ABSTRACT

A method includes receiving an ambisonics recording within a scene. The ambisonics recording includes a target sound and other sounds in the scene. The method includes receiving directional parameters indicating a direction of a source of the target sound in the scene. The method includes receiving a text description of the target sound within the scene. The method includes processing, using a semantic encoder, the text description of the target sound to generate a semantic embedding vector. The method includes concatenating the semantic embedding vector with the directional parameters to generate a conditioning vector. The method includes processing, using a neural network conditioned on the conditioning vector, the ambisonics recording to generate an enhanced audio signal that isolates the target sound in the scene from the other sounds in the scene.

### CROSS REFERENCE TO RELATED APPLICATIONS

This U.S. Patent Application claims priority under 35 U.S. C. § 119(e) to U.S. Provisional Application 63/694,158, filed on Sep. 12, 2024. The disclosure of this prior application is considered part of the disclosure of this application and is hereby incorporated by reference in its entirety.

### TECHNICAL FIELD

This disclosure relates to direction and semantics driven ambisonic target sound extraction.

### BACKGROUND

With the proliferation of virtual and augmented reality (VR/AR) systems, there is an increasing demand for immersive spatial audio experiences that allow users to interact with their acoustic environment. Ambisonics is a popular spatial audio format used to create these experiences, representing a complete sound field around a listener to enable dynamic, head-tracked audio rendering. In many scenarios, an ambisonic recording captures a complex mixture of sounds originating from multiple sources within a scene. Some signal processing techniques have been developed to manipulate these recordings, such as directional loudness modification, beamforming, and multi-channel Wiener filtering, which aim to isolate a target sound based on its direction of arrival. However, the performance of these spatially-driven techniques is often ineffective in challenging situations where interfering sounds originate from a direction that is spatially close to the desired target sound, making it difficult to separate the target from nearby acoustic interference.

### SUMMARY

One aspect of the disclosure provides a computer-implemented method executed on data processing hardware that causes the data processing hardware to perform operations for ambisonic target sound extraction. The operations include receiving an ambisonics recording within a scene. The ambisonics recording including a target sound and other sounds in the scene. The operations include receiving directional parameters indicating a direction of a source of the target sound in the scene. The operations include receiving a text description of a target sound within the scene. Using a semantic encoder, the operations include processing the text description of the target sound to generate a semantic embedding vector. The operations include concatenating the semantic embedding vector with the directional parameters to form a conditioning vector. The operations include processing, using a symmetric encoder-decoder U-net neural network conditioned on the conditioning vector, the ambisonics recording to generate an enhanced audio signal that isolates the target sound in the scene from the other sounds in the scene.

Implementations of the disclosure may include one or more of the following optional features. In some implementations, the enhanced audio signal isolates the target sound in the scene from other sounds in the scene by suppressing the other sounds in the scene and preserving the target sound. The enhanced audio signal may isolate the target sound in the scene from the other sounds in the scene by increasing a volume of the target sound. In some examples, the enhanced audio signal isolates the target sound in the scene from the other sounds in the scene by suppressing the target sound and preserving the other sounds in the scene.

In some implementations, the symmetric encoder-decoder U-net neural network includes a plurality of encoder layers, a plurality of decoder layers, and a plurality of feature-wise linear modulation (FiLM) modules applied to the encoder layers, the decoder layers, and a bottleneck between the encoder layers and the decoder layers. The directional parameters may include an azimuth angle and an elevation angle of the source of the target sound in the scene relative to a head position of the user. In some examples, the operations further include generating, using an image captioning model, the text description of the target sound within the scene based on a segmented region of a video frame corresponding to the direction of the source of the target sound. In some implementations, the operations further include training the symmetric encoder-decoder U-net neural network on a training dataset that includes synthetic ambisonic audio mixtures. Here, the operations may further include simulating a plurality of ambisonic room impulse response, generating convolved outputs by convolving the plurality of ambisonic room impulse responses with a plurality of mono audio source waveforms, and generating the synthetic ambisonic audio mixtures based on the convolved outputs. In these implementations, the training dataset may further include real ambisonic audio mixtures.

Another aspect of the disclosure provides a system that includes data processing hardware and memory hardware storing instructions that when executed on the data processing hardware causes the data processing hardware to perform operations. The operations include receiving an ambisonics recording within a scene. The ambisonics recording including a target sound and other sounds in the scene. The operations include receiving directional parameters indicating a direction of a source of the target sound in the scene. The operations include receiving a text description of a target sound within the scene. Using a semantic encoder, the operations include processing the text description of the target sound to generate a semantic embedding vector. The operations include concatenating the semantic embedding vector with the directional parameters to form a conditioning vector. The operations include processing, using a symmetric encoder-decoder U-net neural network conditioned on the conditioning vector, the ambisonics recording to generate an enhanced audio signal that isolates the target sound in the scene from the other sounds in the scene.

Implementations of the disclosure may include one or more of the following optional features. In some implementations, the enhanced audio signal isolates the target sound in the scene from other sounds in the scene by suppressing the other sounds in the scene and preserving the target sound. The enhanced audio signal may isolate the target sound in the scene from the other sounds in the scene by increasing a volume of the target sound. In some examples, the enhanced audio signal isolates the target sound in the scene from the other sounds in the scene by suppressing the target sound and preserving the other sounds in the scene.

In some implementations, the symmetric encoder-decoder U-net neural network includes a plurality of encoder layers, a plurality of decoder layers, and a plurality of feature-wise linear modulation (FiLM) modules applied to the encoder layers, the decoder layers, and a bottleneck between the encoder layers and the decoder layers. The directional parameters may include an azimuth angle and an elevation angle of the source of the target sound in the scene relative to a head position of the user. In some examples, the operations further include generating, using an image captioning model, the text description of the target sound within the scene based on a segmented region of a video frame corresponding to the direction of the source of the target sound. In some implementations, the operations further include training the symmetric encoder-decoder U-net neural network on a training dataset that includes synthetic ambisonic audio mixtures. Here, the operations may further include simulating a plurality of ambisonic room impulse response, generating convolved outputs by convolving the plurality of ambisonic room impulse responses with a plurality of mono audio source waveforms, and generating the synthetic ambisonic audio mixtures based on the convolved outputs. In these implementations, the training dataset may further include real ambisonic audio mixtures.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for direction and semantics driven ambisonic target sound extraction.

FIG. 2 is a schematic view of an example neural network.

FIG. 3 is a schematic view of an example training process for the neural network.

FIG. 4 is a flowchart of an example arrangement of operations for a computer-implemented method for ambisonic target sound extraction.

FIG. 5 is a schematic view of an example computing device that may be used to implement the systems and methods described herein.

Like reference symbols in the various drawings indicate like elements.

### DETAILED DESCRIPTION

The recent proliferation of virtual and augmented reality (VR/AR) technologies has created a substantial demand for highly immersive user experiences. An important component of this immersion is spatial audio, which provides listeners with a three-dimensional sense of their acoustic surroundings, allowing them to perceive the location and movement of sound sources within a virtual environment. By accurately recreating how sound behaves in a real-world space, spatial audio significantly enhances the realism and interactivity of applications ranging from virtual meetings and remote collaboration to gaming and entertainment.

A popular and powerful format for capturing, representing, and rendering spatial audio is ambisonics. Ambisonics represents a complete 360-degree sound field surrounding a point in space using a mathematical basis known as spherical harmonics. This representation may be recorded using specialized spherical microphone arrays and is particularly well-suited for VR applications because it allows for the audio scene to be dynamically rotated to match head movements of a user, a process known as head-tracked binaural rendering. This capability ensures that the perceived directions of sounds remain stable and consistent as the user looks around the virtual world, which is essential for a convincing immersive experience.

In practice, ambisonic recordings of real-world environments often capture complex and dense acoustic scenes containing a mixture of numerous sound sources, For example, a recording of a busy city park may include the sounds of a street musician, nearby conversations, passing traffic, and other ambient noises all occurring simultaneously. Within such a mixed sound field, a user or application may desire to focus on a single target sound source. For instance, to isolate the musician's performance while attenuating or removing all other interfering sounds in the scene.

To address this need, various signal processing techniques have been developed to manipulate ambisonic recordings and extract target sound fields. Some methods employ directional loudness modification, which works by preserving the loudness of sounds within a defined spherical cap centered on a target direction while suppressing sounds outside of that region. Other approaches utilize beamforming and multi-channel Wiener filtering to estimate the signal of a target source. However, a significant limitation of these conventional techniques is their primary reliance on spatial information. Their effectiveness diminishes considerably in acoustically crowded scenarios where an interfering sound source is located in close spatial proximity to the desired target sound, as they often fail to adequately separate the target from the nearby interference

Accordingly, implementations are directed towards an extraction model. The extraction model receives an ambisonics recording within a scene. The ambisonics recording includes a target sound and other sounds in the scene. The extraction model receives directional parameters indicating a direction of a source of the target sound in the scene. The extraction model obtains a text description of a target sound within the scene and processes, using a semantic encoder, the text description of the target sound to generate a semantic embedding vector. The extraction model concatenates the semantic embedding vector with the directional parameters to form a conditioning vector. Using a neural network conditioned on the conditioning vector, the extraction model processes the ambisonics recording to generate an enhanced audio signal that isolates the target sound in the scene from the other sounds in the scene.

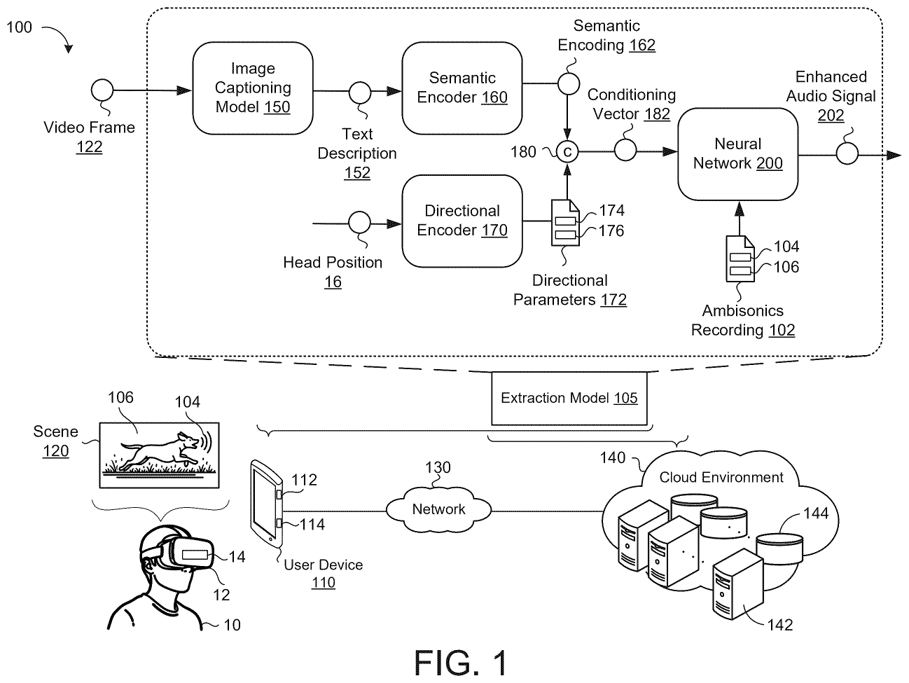

Referring to FIG. 1, in some implementations, a system 100 includes a remote computing system 140 in communication with one or more user devices 110 each associated with a respective user 10 via a network 130, such as the Internet, a local area network (LAN), a wide area network (WAN), a cellular network, or a wireless network. The remote computing system 140 may be a single computer, multiple computers, or a distributed system (e.g., a cloud environment) having scalable/elastic resources including computing resources 142 (e.g., data processing hardware) and/or storage resources 144 (e.g., memory hardware). The remote computing system 140 is configured to communicate with the user device 110 via the network 130.

The user device 110 may correspond to any computing device, such as a desktop workstation, a laptop workstation, a mobile device (i.e., a smart phone), or a wearable device (i.e., a smartwatch). Each user device 110 includes computing resources 112 (e.g., data processing hardware) and/or storage resources 114 (e.g., memory hardware). The user device 110 may also include an audio input device (e.g., a microphone) and an audio output device (e.g., a speaker) for capturing and playing audio data, respectively. The user device 110 may further include a display device (e.g., a screen) for presenting visual information to the user 10.

In some examples, the user device 110 operates in conjunction with an augmented reality (AR) or a virtual reality (VR) headset (i.e., AR/VR headset) 12 that the user 10 wears. In other examples, the user device 110 functions as the AR/VR headset 12. The AR/VR headset 12 may deliver an immersive audio-visual experience for the user 10. The AR/VR headset 12 may include one or more speakers to deliver audio to the user 10 and a display to deliver visual information to the user 10. For example, the user 10 may view a 360-degree panoramic video, which includes an accompanying spatial audio presentation, on the AR/VR headset 12. In alternative configurations, the user device 110, for instance a mobile phone or a computer, may communicate with a separate AR/VR headset 12. In such a configuration, the user device 110 may execute a portion of or all of the processing operations, while the headset 12 delivers the audio-visual output to the user 10.

The AR/VR headset 12, whether it is the user device 110 or a peripheral in communication with the user device 110, may be equipped with various sensors 14 to track the interactions of the user 10 with a scene 120 displayed on a screen of the AR/VR headset 12. For example, the AR/VR headset 12 may include an inertial measurement unit (IMU) or other motion sensors. The sensors 14 may determine the orientation and movement of the head of the user 10. Data from the IMU, for example, may be processed to determine a head position 16 of the user 10. The head position 16 may be defined by an angle of the head of the user 10 relative to a coordinate system of the scene 120. The processing may include tracking changes in orientation, such as yaw, pitch, and roll, as the user 10 moves. A change in the head position 16 may adjust audio rendering of the AR/VR headset 12, thereby ensuring that a perceived direction of a sound source remains stable as the user 10 looks around. For example, if a target sound originates from a fixed point in the scene 120, and the user 10 turns their head to the left, the audio rendering adjusts to make the sound appear to come from the right of the user 10, maintaining a consistent spatial perception.

In addition to tracking the head position 16, the system may process one or more auxiliary inputs to determine a focus of the user 10 within the scene 120. The auxiliary input may correspond to an intentional action performed by the user 10 to identify a particular object or region of interest. For example, the user 10 may perform a hand gesture, such as pointing a finger or a controller, toward a specific sound source within the visual representation of the scene 120. A hand-tracking system, potentially utilizing cameras integrated into the AR/VR headset 12 or external sensors, may detect such a gesture. Upon detection, the hand-tracking system may determine a directional vector that originates from the hand or controller of the user 10 and extends into the scene 120. The system may then determine an intersection of the directional vector with the geometry of the visual scene 120 to identify a specific target object or location that the user 10 is indicating.

As another example, the system may track a gaze direction of the user 10. The AR/VR headset 12 may incorporate eye-tracking sensors, such as infrared cameras and illuminators, positioned within the headset to monitor the pupils of the user 10. Data from the eye-tracking sensors allows the system to determine a precise point or region within the scene 120 at which the user 10 is looking. By combining data related to the head position 16 with data from the gaze direction and/or the hand gesture, the system may determine with greater accuracy where within the scene 120 the attention of the user 10 is focused, thereby identifying the source of the target sound 104.

An extraction model 105 may execute on the AR/VR device 12, the user device 110, and/or the remote computing system 140. In some examples, some components of the extraction model 105 execute on the user device 110 while other components execute on the remote computing system 140. The extraction model 105 processes an ambisonics recording 102 to isolate a target sound 104 from other sounds 106 in the scene 120. The ambisonics recording 102 corresponds to the spatial audio component of the scene 120 that is presented to the user 10, for example, on the AR/VR device 12. The scene 120 may be an immersive visual environment, such as a 360-degree panoramic video, and the ambisonics recording 102 provides the accompanying head-tracked spatial audio. This allows for a synchronized audio-visual experience where the perceived direction of sounds within the scene 120 remains consistent with the visual elements as the user 10 changes their head position 16.

The extraction model 105 may include a semantic encoder 160, a directional encoder 170, and a symmetric encoder-decoder U-net neural network 200, which may also be referred to simply as the neural network 200. The extraction model 105 receives as input the ambisonics recording 102 captured within the scene 120. In some implementations, both the ambisonics recording 102 and the associated scene 120 are prerecorded, such as a one-minute video with accompanying spatial audio. In other examples, the processing may occur with a lower latency on a live audio stream. The ambisonics recording 102 represents a full-sphere sound field and includes audio data for both a desired target sound 104 and other sounds 106 present within the scene 120. For example, in the scene 120 of a city park, the target sound 104 may be a person speaking, while the other sounds 106 could include traffic noise, birds chirping, and distant conversations. In the example shown, the scene 120 includes a dog in a field whereby the dog barking is the target sound 104, while the environmental noises are the other sounds 106.

In some implementations, the extraction model 105 receives directional parameters 172. The directional parameters 172 provide quantitative information indicating a specific direction of a source of the target sound 104 within the three-dimensional space of the scene 120. For instance, the directional parameters 172 may define a vector or a set of angles that precisely locate the source of the target sound 104 relative to a reference frame. In some configurations, the extraction model 105 includes a directional encoder 170 that generates the directional parameters 172 based on user interactions or sensor data. For example, the directional encoder 170 generates the directional parameters 172 based on the head position 16 of the user 10. The head position 16, which is tracked by sensors 14 such as the IMU within the AR/VR headset 12, provides a reference orientation for the user 10 within the scene 120. This reference orientation allows the system to establish a coordinate system from the perspective of the user 10, against which the direction of the target sound 104 may be measured and represented.

Optionally, the directional encoder 170 may combine the head position 16 with an additional user input, such as a pointing gesture made with a hand or a controller, or a specific gaze direction identified by eye-tracking sensors. The directional encoder 170 then determines the precise location of the sound source indicated by the combined input. The directional parameters 172 may be numerically represented as an azimuth angle 174 and an elevation angle 176 relative to a reference point, such as a coordinate system centered on the head position 16 of the user 10. The azimuth angle 174 specifies the horizontal direction of the source of the target sound 104, while the elevation angle 176 specifies the vertical direction of the source of the target sound 104.

In some examples, the extraction model 105 may include an image captioning model 150 configured to analyze visual data associated with the scene 120. The image captioning model 150 may receive, as input, a video frame 122 or a segmented region of the video frame 122 that corresponds to the direction of the source of the target sound 104. For instance, if the user 10 points or looks towards a visual object in an immersive video (e.g., the scene 120), a corresponding region of the video frame 122 may be isolated. The image captioning model 150 processes the corresponding region to identify the object or action depicted and subsequently generates a natural language text description 152. For example, the segmented region of the video frame 122 includes a dog, the image captioning model 150 may generate the text description 152 as “a dog barking.” In another example, if the user points towards a musician playing a guitar, the image captioning model 150 may generate the text description 152 as “a person playing a guitar.” The automated generation of the text description 152 provides a mechanism for identifying the target sound 104 without requiring explicit textual input from the user 10.

The semantic encoder 160, which may be a text encoder model such as a Bidirectional Encoder Representations from Transformers (BERT) model or a contrastively trained text-sound encoder, processes the text description 152 of the target sound 104 to generate a semantic embedding vector 162. The semantic embedding vector 162 is a numerical, high-dimensional representation that captures the semantic meaning of the text description 152. For instance, if the text description 152 is “a dog barking,” the semantic encoder 160 transforms the text description 152 text into a vector that numerically represents the concept of a barking dog. The semantic embedding vector 162 provides a rich, descriptive input to subsequent components of the extraction model 105.

The extraction model 105 may include a concatenator 180 that generates a conditioning vector 182 by combining the semantic embedding vector 162 with the directional parameters 172. In some configurations, the concatenator 180 combines the vectors by concatenating the two vectors, creating a single, longer vector that includes both semantic and spatial information. The directional parameters 172 specify the spatial location of the source of the target sound 104. For example, the directional parameters 172 may include the azimuth angle 174 and the elevation angle 176. The azimuth angle 174 represents the horizontal direction of the source of the target sound 104, while the elevation angle 176 represents the vertical direction of the source, both measured relative to a reference coordinate system, such as one centered on the head position 16 of the user 10. The resulting conditioning vector 182 serves as a comprehensive input that informs the neural network 200 about both what sound to isolate (e.g., from the semantic embedding vector 162) and where that sound is located in the scene 120 (e.g., from the directional parameters 172).

The extraction model 105 subsequently conditions the neural network 200 on the conditioning vector 182. The conditioning process integrates both the semantic information (e.g., what the target sound 104 is) and the spatial information (e.g., where the target sound 104 is located) into the operational parameters of the neural network 200. Once conditioned, the neural network 200 processes the ambisonics recording 102, which includes the target sound 104 and the other sounds 106. The processing performed by the conditioned neural network 200 effectively acts as a highly selective filter, designed to pass through audio components that match the characteristics defined by the conditioning vector 182 while attenuating others. The output of this processing is an enhanced audio signal 202. The enhanced audio signal 202 represents an isolated version of the target sound 104, substantially separated from the other sounds 106 that were present in the original ambisonics recording 102. For example, if the target sound 104 is a guitar playing at a specific location and the other sounds 106 include traffic and speech, the enhanced audio signal 202 will predominantly (or only) include the guitar audio, preserving the spatial characteristics of the sound field of the guitar while suppressing the audio corresponding to the traffic and speech.

For instance, the neural network 200 may generate the enhanced audio signal 202 by performing a suppression operation on the ambisonics recording 102. This operation effectively reduces the amplitude or energy of audio components corresponding to the other sounds 106, while leaving the audio components associated with the target sound 104 largely unaltered. For example, the scene 120 may correspond to a busy city park where the target sound 104 is a person speaking and the other sounds 106 include traffic noise and nearby conversations. After processing by the conditioned neural network 200, the resulting enhanced audio signal 202 would include the speech signal with its original spatial characteristics preserved, but the sounds of traffic and the other conversations would be significantly attenuated or rendered inaudible. This form of isolation is akin to creating a cone of silence around everything except the target sound source, allowing the user 10 to focus on the desired audio without distraction from interfering sounds. The neural network 200 learns to distinguish the target sound 104 from the other sounds 106 based on both the specified direction from the directional parameters 172 and the semantic description from the semantic embedding vector 162.

In another example, the neural network 200 may be configured to amplify the target sound 104 relative to the other sounds 106. In this configuration, the enhanced audio signal 202 is generated by first isolating the target sound 104, as previously described, to create an isolated target signal. A gain factor, which may be a predetermined value or a user-adjustable parameter, is then applied to the isolated target signal to increase the amplitude of the isolated target signal. For instance, the isolated target signal may be multiplied by a gain factor of two to double the volume of the isolated target signal. The amplified target signal is then added back to the original ambisonics recording 102. The result is the enhanced audio signal 202, in which the volume of the target sound 104 is increased while the volumes of the other sounds 106 remain at their original levels. This operation effectively makes the target sound 104 more prominent within the overall acoustic scene 120 without completely removing the other sounds 106.

Conversely, the neural network 200 may generate the enhanced audio signal 202 by performing an inverted isolation, where the goal is to remove the target sound 104 from the ambisonics recording 102. In this operational mode, the neural network 200 first isolates the target sound 104, creating a signal that includes only the audio components of the target source. Then, the neural network 200 subtracts the isolated target sound signal from the original ambisonics recording 102. The result of this subtraction is the enhanced audio signal 202, which includes all the other sounds 106 from the scene 120 while the target sound 104 is suppressed or entirely removed. For example, if the user 10 wishes to remove the sound of a barking dog from a park recording, the neural network 200 would first isolate the dog barking sound based on the provided direction and text description. This isolated barking sound is then subtracted from the full park recording, producing the enhanced audio signal 202 that preserves the ambient sounds of the park but without the bark of the dog. This capability allows for the selective removal of specific unwanted sounds from a complex acoustic environment.

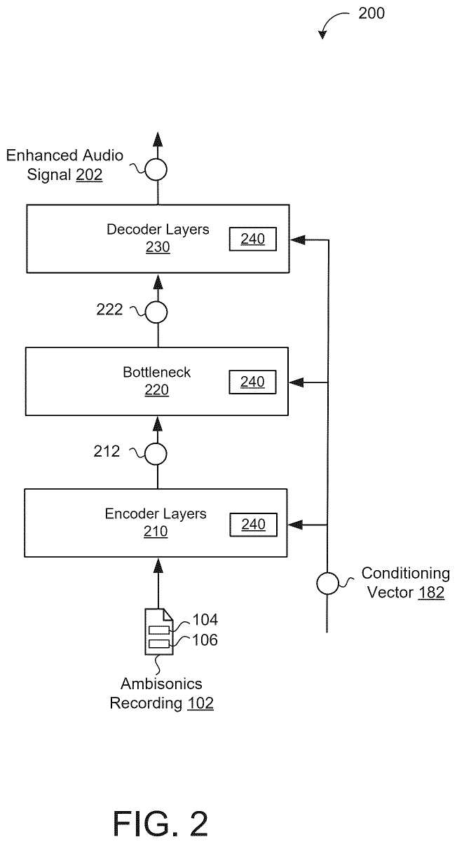

Referring now to FIG. 2, in some implementations, the neural network 200 includes a plurality of encoder layers 210 that form an encoding path, a plurality of decoder layers 230 that form a decoding path, and a bottleneck 220 that connects the encoding path to the decoding path. The plurality of encoder layers 210 process the input ambisonics recording 102 through a series of operations configured to progressively downsample the audio data and extract hierarchical feature representations at different scales. For instance, each encoder layer 210 of the plurality of encoder layers 210 may apply one or more convolutional operations, followed by a downsampling operation, such as max-pooling or strided convolution. A function of the downsampling operations is to reduce spatial dimensions of feature maps while simultaneously increasing a number of feature channels, thereby creating a more compressed yet information-rich representation of the audio. The plurality of encoder layers 210 generates an encoding output 212.

The bottleneck 220 generates a bottleneck output 222 based on the encoding output 212. The plurality of decoder layers 230 receive the bottleneck output 222 from the bottleneck 220 and progressively upsample the feature representations to reconstruct the audio signal. The plurality of decoder layers 230 ultimately generate the enhanced audio signal 202. The structure of the plurality of decoder layers 230 may mirror the structure of the plurality of encoder layers 210. For example, the plurality of decoder layers 230 may use upsampling operations, such as transposed convolutions, to systematically increase the spatial dimensions of the feature maps. Additionally, skip connections may be established between the encoding path and the decoding path. Such skip connections may concatenate or sum feature maps from the encoder layer 210 with corresponding feature maps in the decoder layer 230 at the same hierarchical level. A technical effect of the skip connections is to allow the decoding path to access and recover fine-grained details captured in the encoding path, which may improve the fidelity of the generated enhanced audio signal 202.

To integrate the conditioning information, the neural network 200 further includes a plurality of feature-wise linear modulation (FiLM) modules 240. The plurality of FiLM modules 240 are configured to receive the conditioning vector 182 and to apply an affine transformation to intermediate feature maps within the neural network 200. Specifically, each FiLM module 240 of the plurality of FiLM modules 240 may generate a scaling parameter and a shifting parameter based on the conditioning vector 182. The generated parameters are then used to scale and shift the feature maps element-wise. The plurality of FiLM modules 240 may be applied to one or more of the plurality of encoder layers 210, the plurality of decoder layers 230, and the bottleneck 220. By applying these learned transformations, the plurality of FiLM modules 240 allow the conditioning vector 182 to dynamically modulate the behavior of the neural network 200. This modulation enables the neural network 200 to adapt processing to isolate the specific target sound 104 indicated by the semantic and directional information. The conditioning vector 182 is provided as an input to each of the plurality of FiLM modules 240, thereby influencing feature extraction and reconstruction processes throughout the neural network 200.

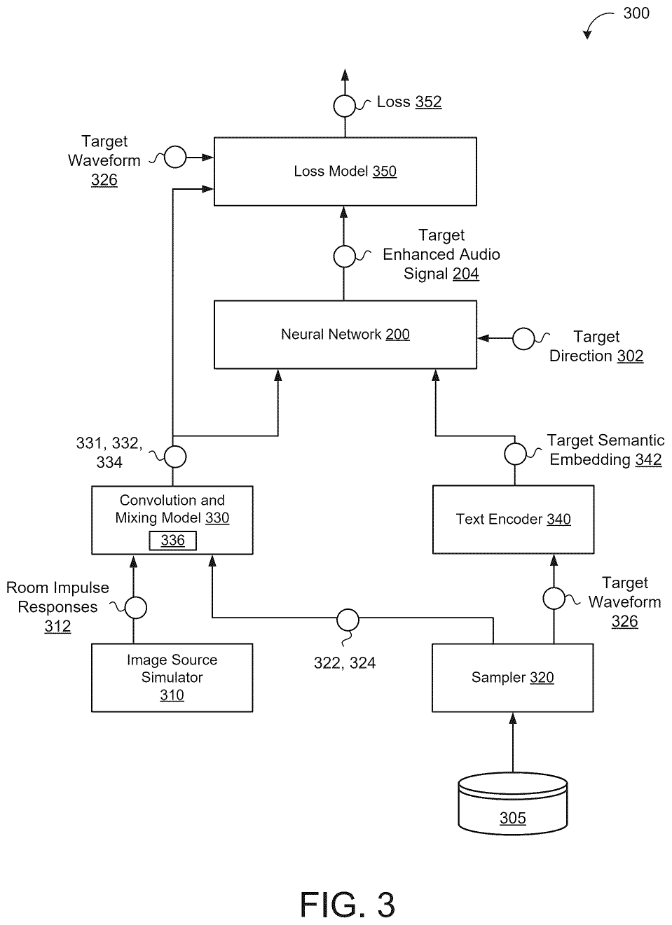

Referring now to FIG. 3, in some implementations, a training process 300 trains the neural network 200 on a training dataset 331. The training process 300 employs an image source simulator 310, a sampler 320, a convolution and mixing model 330, a text encoder 340, and a loss model 350. That is, the training process 300 trains the neural network 200 using on the training dataset 331, which may include a combination of computationally generated synthetic ambisonic audio mixtures 332 and real ambisonic audio mixtures 334 recorded in actual acoustic environments. The use of a hybrid dataset allows the neural network 200 to learn from a wide variety of acoustic scenarios, thereby improving the generalizability of the neural network 200.

To generate the synthetic ambisonic audio mixtures 332, the image source simulator 310 generates a plurality of ambisonic room impulse responses 312. Each ambisonic room impulse response 312 characterizes how sound propagates from a source to a receiver within a simulated three-dimensional space, accounting for reflections, reverberation, and spatial directionality. The image source simulator 310 may generate a diverse set of the ambisonic room impulse responses 312 by systematically varying parameters of the simulated environment. For example, the image source simulator 310 may simulate rooms with different dimensions (e.g., small, reverberant chambers or large, open halls), different surface materials (e.g., acoustically reflective surfaces like concrete or absorptive surfaces like curtains), and different positions for sound sources and the ambisonic receiver. This process creates a large and varied library of acoustic conditions.

In parallel with the simulation of acoustic environments, the sampler 320 obtains a diverse collection of audio waveforms from a data source 305. The data source 305 may correspond to one or more publicly available or proprietary audio libraries. The sampler 320 selects a plurality of mono audio source waveforms 322 from the data source 305. The mono audio source waveforms 322 may represent a wide range of sound types, such as human speech, various musical instruments, animal sounds (e.g., a dog barking), and environmental noises. For example, speech waveforms may be sourced from datasets like Libri-Light, while general sound effects may be obtained from datasets such as Clotho or FSD50k. In some configurations, the sampler 320 also selects a plurality of ambisonic audio source waveforms 324, which are pre-existing spatial audio recordings. From the selected waveforms, the sampler 320 designates a specific waveform as a target audio source waveform 326, which will represent the sound to be isolated during a given training iteration. The remaining non-target waveforms function as interfering or background sounds in the synthetic mixture.

The convolution and mixing model 330 functions to create realistic and diverse acoustic scenes for training the neural network 200. The process begins by taking each individual mono audio source waveform 322 and applying a simulated acoustic environment to the mono audio source waveform 322. This is achieved through convolution, an operation that effectively “places” the sound from a mono audio source waveform 322 into a simulated three-dimensional space characterized by one of the plurality of ambisonic room impulse responses 312. For example, a mono recording of speech may be convolved with an ambisonic room impulse response 312 corresponding to a large, reverberant hall. The result of this operation is a new ambisonic waveform that represents what the speech would sound like if spoken from a specific location within that hall, complete with spatial cues such as directionality and reverberation.

The convolution and mixing model 330 performs this convolution for multiple mono audio source waveforms 322, each paired with a distinct ambisonic room impulse response 312 to simulate multiple sound sources within the same acoustic scene. In some examples, the convolution and mixing model 330 may also incorporate the plurality of ambisonic audio source waveforms 324, which already include spatial information. The collection of these individual spatialized waveforms are the convolved outputs 336.

Subsequently, the convolution and mixing model 330 generates the synthetic ambisonic audio mixtures 332 by summing or otherwise combining the plurality of convolved outputs 336. For instance, a convolved output representing speech in a hall may be mixed with another convolved output representing music in the same hall. The resulting synthetic ambisonic audio mixture 332 is a complex, multi-source ambisonic recording that simulates a realistic acoustic environment with multiple, spatially distinct sounds. This process is repeated numerous times with different combinations of waveforms and impulse responses to generate a large and varied training dataset 331.

In parallel with the creation of the synthetic ambisonic audio mixtures 332, the text encoder 340 generates a target semantic embedding 342. The text encoder 340, which may be a pre-trained language model, receives a textual description associated with the target audio source waveform 326. For example, if the target audio source waveform 326 corresponds to a dog barking, the textual description may be “dog barking” or a similar phrase derived from the metadata of the data source 305. The text encoder 340 processes this textual description to produce the target semantic embedding 342, which is a high-dimensional numerical vector. This vector encapsulates the semantic meaning of the target sound, providing a rich, descriptive representation that distinguishes the target sound from other sound types. In some examples, the text encoder 340 may be a model, such as SoundWords, that is specifically trained to create a joint embedding space for both text and audio, thereby producing embeddings that are more acoustically aware. Alternatively, a general-purpose text encoder, such as a BERT model, may be utilized. The resulting target semantic embedding 342 serves as a conditioning input for the neural network 200 during the training process 300.

During a training iteration, the neural network 200 receives multiple inputs to learn how to perform the target sound extraction task. The neural network 200 receives a synthetic ambisonic audio mixture 332 or a real ambisonic audio mixture 334 from the training dataset 331 as the primary input signal to be processed. Concurrently, the neural network 200 receives the conditioning information that specifies which sound within the mixture is the target. This conditioning information includes the target semantic embedding 342, which describes the acoustic characteristics of the target sound, and a target direction 302, which specifies the spatial location of the target sound source. In some implementations, the neural network 200 receives a concatenation of the target semantic embedding 342 and the target direction 302. The target direction 302 corresponds to the direction of the target audio source waveform 326 used to generate the mixture. Based on these inputs, the neural network 200 processes the audio mixture and generates a target enhanced audio signal 204. The objective of the neural network 200 during training is to make the generated target enhanced audio signal 204 as close as possible to the ground-truth isolated target audio, which is derived from the target audio source waveform 326.

To evaluate the performance of the neural network 200 during training, the loss model 350 determines a loss 352. The loss 352 quantifies a discrepancy between the target enhanced audio signal 204, which is the output generated by the neural network 200, and a ground-truth isolated target audio signal. The ground-truth isolated target audio signal is derived directly from the convolved output 336 that corresponds to the target audio source waveform 326. For example, the ground-truth isolated target audio signal is the spatialized version of the target audio source waveform 326 before mixing with other sounds. The loss model 350 may calculate the loss 352 as a distance metric between these two signals in a specific domain. In some examples, the loss model 350 first converts both the target enhanced audio signal 204 and the ground-truth signal into a time-frequency representation, such as a complex short-time Fourier transform (STFT). The loss model 350 then computes an LI distance between the magnitudes of the complex values of the two STFT representations, averaged across all ambisonic channels, time frames, and frequency bins. The training process 300 uses the resulting loss 352 to update the parameters of the neural network 200 through a backpropagation algorithm, guiding the neural network 200 to produce outputs that more closely match the ground-truth isolated target audio.

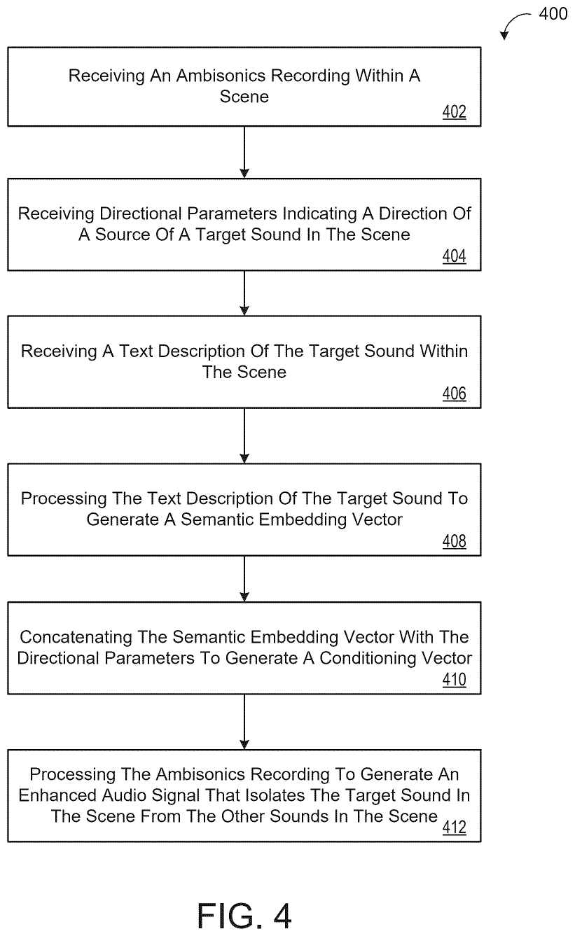

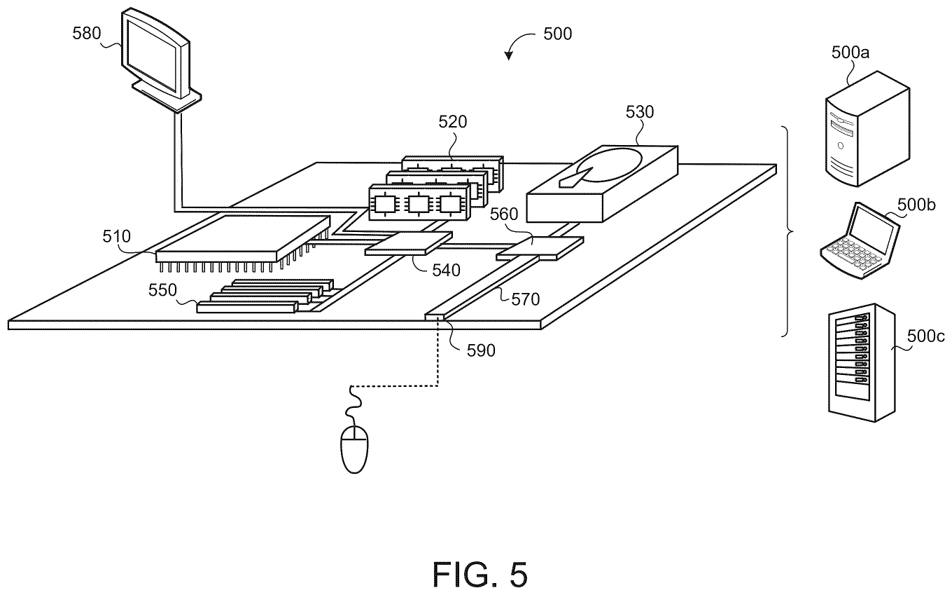

FIG. 4 is a flowchart of an example arrangement of operations for a computer-implemented method 400 for ambisonic target sound extraction. The method 400 may execute on data processing hardware 510 (FIG. 5) using instructions stored on memory hardware 520 (FIG. 5). The data processing hardware 510 and the memory hardware 520 may reside on the user device 110 and/or the remote computing system 140 of FIG. 1 each corresponding to the computing device 500 (FIG. 5).

At operation 402, the method 400 includes receiving an ambisonics recording 102 within a scene 120. The ambisonics recording 102 includes a target sound 104 and other sounds 106 in the scene 120. At operation 404, the method 400 includes receiving directional parameters 172 indicating a direction of a source of the target sound 104 in the scene 120. At operation 406, the method 400 includes receiving a text description 152 of the target sound 104 within the scene 120. At operation 408, the method 400 includes processing, using a semantic encoder 160, the text description 152 of the target sound 104 to generate a semantic embedding vector 162. At operation 410, the method 400 includes concatenating the semantic embedding vector 162 with the directional parameters 172 to generate a conditioning vector 182. At operation 412, the method 400 includes processing, using a symmetric encoder-decoder U-net neural network 200 conditioned on the conditioning vector 182, the ambisonics recording 102 to generate an enhanced audio signal 202 that isolates the target sound 104 in the scene from the other sounds 106 in the scene 120.

The extraction model 105 provides technical advantages by leveraging a combination of both spatial and semantic information to perform target sound extraction from ambisonic recordings 102. Conventional techniques primarily rely on spatial information, such as the direction of arrival of a sound source, to perform separation. However, these spatially-driven methods are often ineffective in challenging acoustic scenarios where interfering sound sources are located in close spatial proximity to a target sound source. By conditioning the neural network 200 on a vector (e.g., conditioning vector 182) that combines both directional parameters 172 and the semantic embedding vector 162 derived from a text description 152 of the target sound 104, the extraction model more effectively distinguishes the target sound 104 from nearby interfering sounds, even when those sounds originate from a similar direction. This dual-conditioning approach allows the neural network 200 to learn and apply a more nuanced and accurate filter, improving the isolation of the target sound field.

Advantageously, the extraction model 105 uses a free-form semantic embedding 162 as the conditioning input. Unlike systems that may be limited to a predefined vocabulary or a discrete set of sound classes, the disclosed approach can process natural language text descriptions of arbitrary sounds. This is achieved by using the semantic encoder 160 to convert a descriptive text string, such as “a person playing a guitar” or “a dog barking,” into a rich, high-dimensional semantic embedding vector 162. This technical implementation provides greater flexibility and adaptability, enabling the extraction model 105 to isolate a wide variety of sounds without being constrained to a fixed classification scheme. The extraction model 105 may thereby handle a more diverse range of real-world acoustic scenes and user requests.

Moreover, the architecture of the extraction model 105 itself presents a further improvement. By employing a symmetric encoder-decoder U-net neural network, the extraction model 105 efficiently processes the ambisonic recording 102 to reconstruct the target sound field. The use of FiLM modules 240 provides an effective mechanism for integrating the combined spatial and semantic conditioning information throughout the neural network 200. The conditioning vector 182 is input into FiLM modules 240 at multiple layers of the encoder and decoder paths, allowing the directional and semantic information to dynamically modulate the feature maps at various stages of processing. This deep integration of conditioning information enables the neural network 200 to more precisely adapt its filtering operations, leading to a higher fidelity separation of the target sound from the mixed ambisonic recording.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit), Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving an ambisonics recording within a scene, the ambisonics recording comprising a target sound and other sounds in the scene;
receiving directional parameters indicating a direction of a source of the target sound in the scene;
receiving a text description of the target sound within the scene;
processing, using a semantic encoder, the text description of the target sound to generate a semantic embedding vector;
concatenating the semantic embedding vector with the directional parameters to generate a conditioning vector; and
processing, using a neural network conditioned on the conditioning vector, the ambisonics recording to generate an enhanced audio signal that isolates the target sound in the scene from the other sounds in the scene.

2. The method of claim 1, wherein the enhanced audio signal isolates the target sound in the scene from the other sounds in the scene by suppressing the other sounds in the scene and preserving the target sound.

3. The method of claim 1, wherein the enhanced audio signal isolates the target sound in the scene from the other sounds in the scene by increasing a volume of the target sound.

4. The method of claim 1, wherein the enhanced audio signal isolates the target sound in the scene from the other sounds in the scene by suppressing the target sound and preserving the other sounds in the scene.

5. The method of claim 1, wherein the neural network comprises a symmetric encoder-decoder U-net neural network comprising:
a plurality of encoder layers;
a plurality of decoder layers; and
a plurality of feature-wise linear modulation (FiLM) modules applied to the encoder layers, the decoder layers, and a bottleneck between the encoder layers and the decoder layers,
wherein the conditioning vector is input to each of the FiLM modules.

6. The method of claim 1, wherein the directional parameters comprise an azimuth angle and an elevation angle of the source of the target sound in the scene relative to a head position of a user.

7. The method of claim 1, wherein the operations further comprise generating, using an image captioning model, the text description of the target sound within the scene based on a segmented region of a video frame corresponding to the direction of the source of the target sound.

8. The method of claim 1, wherein the operations further comprise training the neural network on a training dataset comprising synthetic ambisonic audio mixtures.

9. The method of claim 8, wherein the operations further comprise:
simulating a plurality of ambisonic room impulse responses;
generating convolved outputs by convolving the plurality of ambisonic room impulse responses with a plurality of mono audio source waveforms; and
generating the synthetic ambisonic audio mixtures based on the convolved outputs.

10. The method of claim 8, wherein the training dataset further comprises real ambisonics audio mixtures.

11. A system comprising:
data processing hardware; and
memory hardware in communication with the data processing hardware, the memory hardware storing instructions that when executed on the data processing hardware cause the data processing hardware to perform operations comprising:
receiving an ambisonics recording within a scene, the ambisonics recording comprising a target sound and other sounds in the scene;
receiving directional parameters indicating a direction of a source of the target sound in the scene;
receiving a text description of the target sound within the scene;
processing, using a semantic encoder, the text description of the target sound to generate a semantic embedding vector,
concatenating the semantic embedding vector with the directional parameters to generate a conditioning vector; and
processing, using a neural network conditioned on the conditioning vector, the ambisonics recording to generate an enhanced audio signal that isolates the target sound in the scene from the other sounds in the scene.

12. The system of claim 11, wherein the enhanced audio signal isolates the target sound in the scene from the other sounds in the scene by suppressing the other sounds in the scene and preserving the target sound.

13. The system of claim 11, wherein the enhanced audio signal isolates the target sound in the scene from the other sounds in the scene by increasing a volume of the target sound.

14. The system of claim 11, wherein the enhanced audio signal isolates the target sound in the scene from the other sounds in the scene by suppressing the target sound and preserving the other sounds in the scene.

15. The system of claim 11, wherein the neural network comprises a symmetric encoder-decoder U-net neural network comprising:
a plurality of encoder layers;
a plurality of decoder layers; and
a plurality of feature-wise linear modulation (FiLM) modules applied to the encoder layers, the decoder layers, and a bottleneck between the encoder layers and the decoder layers,
wherein the conditioning vector is input to each of the FiLM modules.

16. The system of claim 11, wherein the directional parameters comprise an azimuth angle and an elevation angle of the source of the target sound in the scene relative to a head position of a user.

17. The system of claim 11, wherein the operations further comprise generating, using an image captioning model, the text description of the target sound within the scene based on a segmented region of a video frame corresponding to the direction of the source of the target sound.

18. The system of claim 11, wherein the operations further comprise training the neural network on a training dataset comprising synthetic ambisonic audio mixtures.

19. The system of claim 18, wherein the operations further comprise:
simulating a plurality of ambisonic room impulse responses;
generating convolved outputs by convolving the plurality of ambisonic room impulse responses with a plurality of mono audio source waveforms; and
generating the synthetic ambisonic audio mixtures based on the convolved outputs.

20. The system of claim 18, wherein the training dataset further comprises real ambisonics audio mixtures.
